(19) United States
(12) Patent Application Publication
(10) Pub. No.: US 2004/0238304 A1
(43) Pub. Date: Dec. 2, 2004

(54) System for an adaptable handle to transport wheeled luggage

(76) Inventor: Ethan Fisher, Orland Park, IL (US)

Correspondence Address: MCANDREWS HELD & MALLOY, LTD, 500 WEST MADISON STREET, SUITE 3400, CHICAGO, IL, 60661

(21) Appl. No.: 10/881,378

(22) Filed: Jun. 29, 2004

Related U.S. Application Data
(63) Continuation-in-part of application No. 10/446,207, filed on May 27, 2003.

(51) Int. Cl. A45C 13/00; A45C 13/30; E05B 1/00; E05B 7/00

(52) U.S. Cl. 190/115; 16/113.1

(57) ABSTRACT

Certain embodiments of the present invention provide a system for transporting wheeled luggage using a handle which adapts to the natural position of a user's hand, arm, wrist, or elbow, decreasing strain on a user pushing or pulling the wheeled luggage. In an embodiment, a ball joint mechanism allows rotation and pivot movement of the adaptable handle. The ball joint mechanism permits the handle to rotate or pivot using a ball joint. In another embodiment, a cross bar mechanism allows rotation and pivot movement of the handle. The cross bar mechanism permits the handle to rotate using a ball encased in a cross bar. The cross bar mechanism permits the handle to pivot using a plurality of end caps which are connected to the cross bar. Alternatively, the crossbar mechanism permits the handle to rotate using a fitted plug which locks the handle to the crossbar.

This application is a continuation in part of application Ser. No. 10/446207 filed May 27, 2003.

### BACKGROUND OF THE INVENTION

The present invention generally relates to a system for ergonomic transportation of luggage. In particular, the present invention relates to a system for a rotating and pivoting luggage handle.

Typically, luggage may be used to transport personal belongings during travel. Many different types of luggage currently exist. For example, luggage may exist in many different shapes, sizes, and materials. Moreover, luggage may have several methods of opening and closing, for example zippers or buttons. Many different techniques for transporting luggage also currently exist. Luggage may be carried, by hand or strapped on a user's back, for example. Furthermore, a user may push or pull wheeled luggage along the ground.

Typically, wheeled luggage has two wheels attached to the bottom of the luggage unit. The wheels may be attached, for example, so when the luggage unit is angled or tilted with relation to the ground, a user may transport the luggage by rolling the luggage unit along the ground.

Typically, the luggage unit has a handle which allows the user to push or pull the wheeled luggage. The handle may be attached to the outside of the luggage unit or attached as part of a retractable device. Modem wheeled luggage handles are generally part of a retractable device. The retractable device typically consists of a plurality of extendable shafts, usually two, which extend from the luggage unit. The end of the extendable shafts which extends from the luggage unit are typically connected by the handle. The handle is usually some sort of rigid apparatus which is incapable of adapting to a user's hand, arm, wrist, or elbow position.

The rigid, inflexible structure of modem wheeled luggage handles may impose stress on a user's hand, arm, wrist, or elbow or may compel a user's hand, arm, wrist, or elbow into an unnatural, uncomfortable position. The luggage unit may become difficult, and even painful, for a user to maneuver.

Therefore, a need exists for a system for transporting wheeled luggage which adapts to the natural position of a user's hand, arm, wrist, or elbow. Such a system may allow easier maneuverability of wheeled luggage while also decreasing strain on the hand, wrist, elbow or arm of a user pushing or pulling the wheeled luggage.

### SUMMARY OF THE INVENTION

Certain embodiments of the present invention provide a system for transporting wheeled luggage using a handle which adapts to the natural position of a user's hand, arm, wrist, or elbow. An embodiment of the invention comprises a ball joint mechanism for allowing rotation and pivot movement of the adaptable handle. The ball joint mechanism comprises a ball joint connected to the adaptable handle by a handle shaft. The ball joint may be within a ball joint assembly. The ball joint assembly may be connected to a handle frame and the handle frame connected to at least one retractable shaft.

The ball joint assembly contains a pivot channel to allow pivot movement of the adaptable handle. Moreover, the wheeled luggage may contain a docking recess to allow the adaptable handle and the handle frame to retreat into the wheeled luggage. The wheeled luggage may comprise at least one shaft channel to allow at least one retractable shaft to retreat into the wheeled luggage. The wheeled luggage may also contain a docking recess to allow the adaptable handle and the handle frame to fold into the wheeled luggage. The ball joint may be connected to the adaptable handle by a screw and washer assembly. Furthermore, the ball joint mechanism may allow the adaptable handle to encompass a plurality of rotation and pivot angles.

In an embodiment, a cross bar mechanism allows rotation and pivot movement of the adaptable handle. The cross bar mechanism comprises the adaptable handle which is connected to a ball encased in a cross bar. The ball allows rotation of the adaptable handle. The cross bar is connected to a plurality of end caps. The end caps allow the adaptable handle to pivot.

Preferably, the adaptable handle may be connected to the ball by a self tapping screw. However, the adaptable handle may be connected to the ball by any technique. A ball cover may also be used to cover the ball encased in the cross bar. The ball may be notched to allow rotation of the adaptable handle. The cross bar may be connected to the plurality of end caps by plugs on the cross bar. Moreover, the plurality of end caps may be connected to a plurality of retractable shafts, each retractable shaft being connected to a single end cap. The end caps may also be connected to the retractable shafts by a self tapping screw. However, the end caps may be connected to the retractable shafts by any technique.

The wheeled luggage may also contain a docking recess to allow the adaptable handle to pivot between the retractable shafts and retreat into the docking recess. The wheeled luggage may also contain a docking recess to allow the adaptable handle to pivot into the wheeled luggage. The cross bar mechanism may allow the adaptable handle to encompass a plurality of rotation and pivot angles.

In an embodiment, a cross bar mechanism allows rotation and pivot movement of the adaptable handle. The cross bar mechanism comprises an adaptable handle which is connected to a cross bar by a fitted plug. The fitted plug allows rotation of the adaptable handle. The cross bar is connected to a plurality of end caps. The end caps allow pivot movement of the adaptable handle. The fitted plug may be tapered to allow the fitted plug to be inserted into a hole in the crossbar. The fitted plug may also have a ridge allowing the fitted plug to lock into the crossbar upon inserting the fitted plug into the hole. The cross bar may be connected to a plurality of end caps by plugs on the cross bar. The plurality of end caps may be connected to a plurality of retractable shafts, each retractable shaft may be connected to a single end cap. The wheeled luggage may contain a docking recess to allow the adaptable handle to pivot between the retractable shafts and retreat into the docking recess. The wheeled luggage may also contain a docking recess to allow the adaptable handle to pivot into the wheeled luggage.

### DESCRIPTION OF THE DRAWINGS

FIG. 1 illustrates an embodiment of the present invention in application.

FIG. 2 illustrates an embodiment of the present invention shown in a retracted perspective view.

FIG. 3 illustrates an embodiment of the present invention shown in an extended perspective view.

FIG. 4 illustrates a detailed perspective of an embodiment of the present invention.

FIG. 5 illustrates a detailed perspective of an embodiment of the present invention.

FIG. 6 illustrates a detailed perspective of an embodiment of the present invention.

FIG. 7 illustrates a front view of an embodiment of the present invention.

FIG. 8 illustrates a detailed perspective of an embodiment of the present invention.

FIG. 9 illustrates a perspective view of an embodiment of the present invention.

FIG. 10 illustrates a perspective view of an embodiment of the present invention.

FIG. 11 illustrates a perspective view of an embodiment of the present invention.

FIG. 12 illustrates a detailed perspective of an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

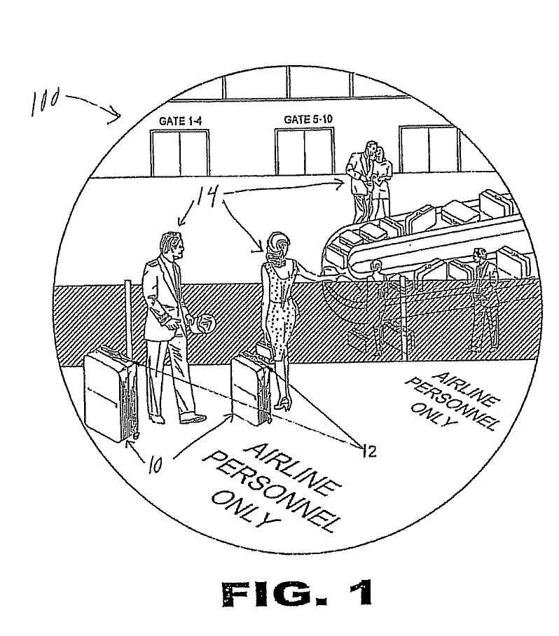

FIG. 1 illustrates a system 100, which demonstrates an application of the present invention. The system 100 shows a wheeled luggage assembly for transporting wheeled luggage 10 using an adaptable handle 12. The wheeled luggage assembly contains an adaptable handle 12 which may pivot or rotate. As shown in FIG. 1, the adaptable handle 12 of the wheeled luggage assembly may be attached to a retractable device, and the retractable device attached to a docking recess. Accordingly, the wheeled luggage assembly may retreat into the wheeled luggage 10.

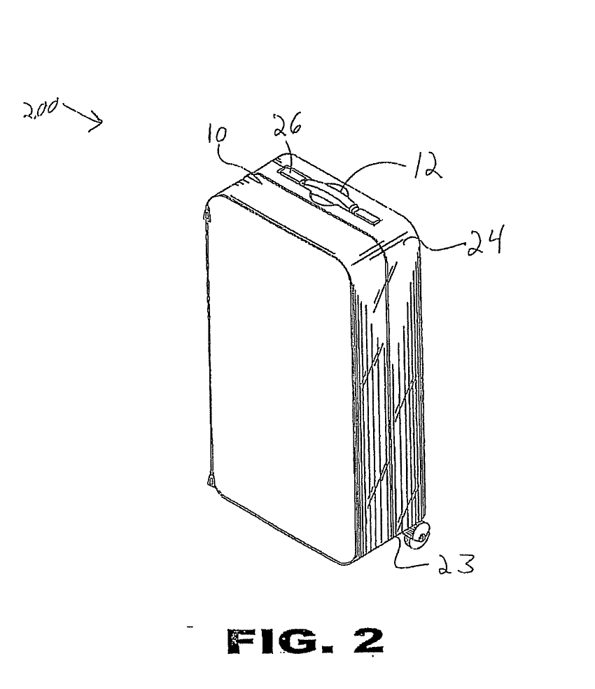

FIG. 2 illustrates a system 200, which shows the wheeled luggage assembly and wheeled luggage 10 of FIG. 1 more closely. The wheeled luggage 10 is shown in a retracted view and has a lower wheeled end 23 and an upper end 24. A handle frame 26 and the adaptable handle 12 are shown retracted into a docking recess 29 (not shown) within the wheeled luggage 10. The docking recess 29 may allow the adaptable handle 12 and the handle frame 26 to retreat into the wheeled luggage 10, as shown. Alternatively, the docking recess 29 may allow the adaptable handle 12 and the handle frame 26 to lay substantially flush with the exterior of the upper end 24 of the wheeled luggage 10. The adaptable handle 12 and the handle frame 26 may fold, for example, to lay substantially flush with the exterior of the upper end 24 of the wheeled luggage 10.

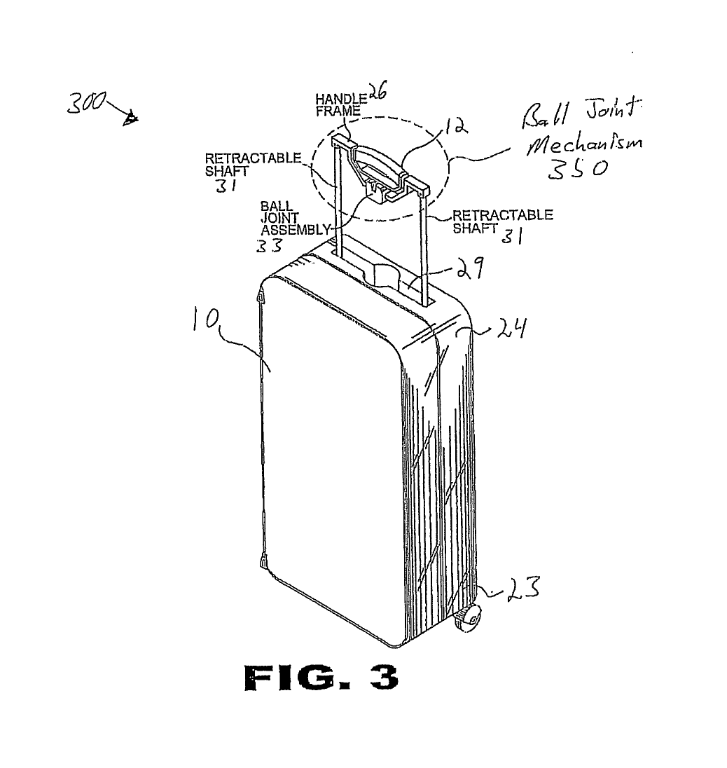

FIG. 3 illustrates a system 300, which shows an extended, perspective view of an embodiment of the present invention. The embodiment of the wheeled luggage assembly as shown in FIG. 3 is a ball joint mechanism 350. The ball joint mechanism 350 allows the adaptable handle 12 to rotate or pivot according to the position of a user's hand, wrist, arm, or elbow, for example. The ball joint mechanism 350 utilizes a ball joint 45 (not shown), among other elements, to allow the adaptable handle 12 to pivot or rotate.

The docking recess 29, as discussed in FIG. 2, is shown in FIG. 3. The wheeled luggage 10 is shown with two retractable shafts 31 extending from the upper end 24 of the wheeled luggage 10. Although the preferred embodiment utilizes two retractable shafts 31, as shown in FIG. 3, any number of retractable shafts 31 may be used, including a single retractable shaft 31. Corresponding shaft channels 32 (not shown) may allow the retractable shafts 31 to retract into the wheeled luggage 10 as shown in FIG. 2. The retractable shafts 31 are attached to the handle frame 26. The handle frame 26 is attached to a ball joint assembly 33. In an embodiment, the ball joint assembly 33 contains a ball joint 45 (not shown). The ball joint assembly 33 and the ball joint 45, among other elements, allow free rotation and pivot movement of the of the adaptable handle 12, thus allowing transportation of the wheeled luggage 10 while allowing a natural, more comfortable, hand, arm, elbow, and wrist position for a user 14.

As used herein, the adaptable handle 12 rotates on an axis substantially parallel to the retractable shafts 31. Moreover, the adaptable handle 12 pivots on an axis substantially perpendicular to the retractable shafts 31. The adaptable handle 12 may pivot and rotate simultaneously allowing the adaptable handle 12 to adapt to any hand, arm, elbow, or wrist position of a user 14. The retractable shafts 31, the handle frame 26, and the adaptable handle 12, may be extended as shown in FIG. 3 by a user pulling the adaptable handle 12, the handle frame 26, or the retractable shafts 31, out of the docking recess 29, for example.

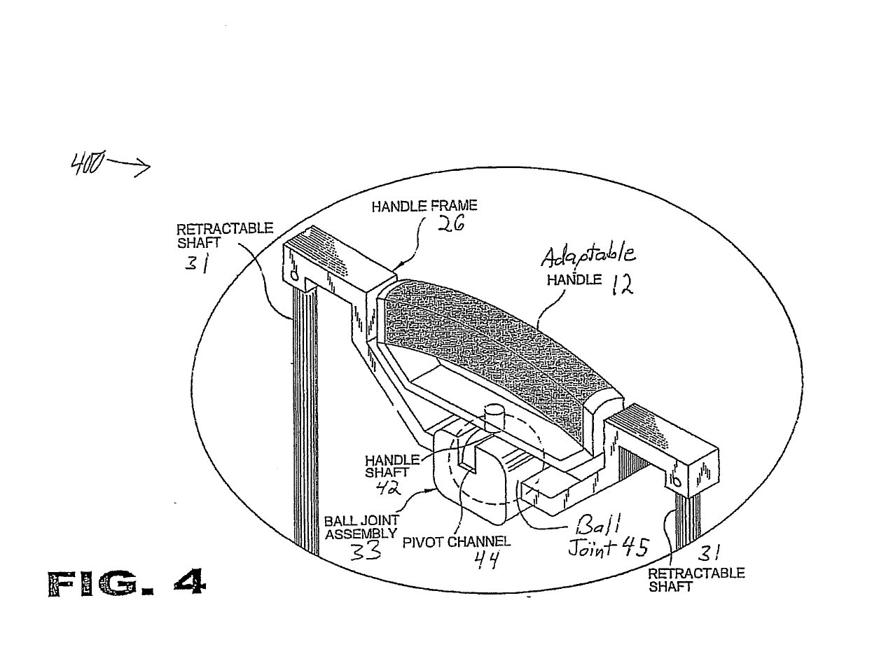

FIG. 4 illustrates a system 400, which shows a detailed view of the ball joint mechanism 350, encircled in FIG. 3. The handle frame 26, the adaptable handle 12, the retractable shafts 31, and the ball joint assembly 33 shown in FIG. 3 are shown in detail in FIG. 4. Moreover, the ball joint 45, mentioned with reference to FIG. 3, is visible in FIG. 4. In an embodiment, the ball joint 45 and ball joint assembly 33, among other elements, allow the adaptable handle 12 to freely rotate. Moreover, the ball joint 45 and ball joint assembly 33 in combination with a pivot channel 44, among other elements, allow the adaptable handle 12 to pivot. The ability of the adaptable handle to rotate or pivot allows the position of the adaptable handle to encompass a plurality of rotation and pivot angles.

The handle shaft 42 connects the adaptable handle 12 to the ball joint 45. In an embodiment, the handle shaft 42 and the ball joint 45 are a single piece. A screw 72 and washer 74 assembly (not shown) may connect the ball joint 45 to the adaptable handle 12 by screwing the adaptable handle 12 into the handle shaft 42. Alternatively, the handle shaft 42 is not part of the ball joint 45. As such, the handle shaft 42 may be part of the adaptable handle 12 or an independent piece 42. In another alternative embodiment, the adaptable handle 12, handle shaft 42, and ball joint 45 are one piece. Accordingly, any technique to attach the ball joint 45 to the adaptable handle 12 may be used.

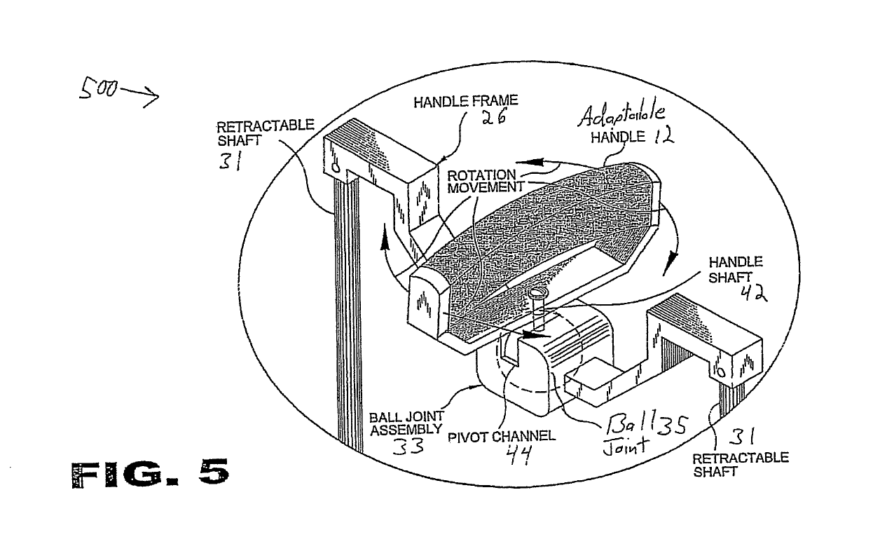

FIG. 5 illustrates a system 500, which shows the detailed perspective 400 with the adaptable handle 12 in a rotated position. The system 500 demonstrates the rotation movement of the adaptable handle 12 in relation to the handle frame 26, the retractable shaft 31, and the wheeled luggage 10, for example. In the preferred embodiment, the adaptable handle 12, the handle shaft 42, and the ball joint 45 may rotate 360 degrees on an axis substantially parallel to the retractable shafts 31. However, the benefits of adaptable handle 12 rotation for a user 14 may be achieved by an adaptable handle 12 which rotates less than 360 degrees. Accordingly, any degree of rotation may be used.

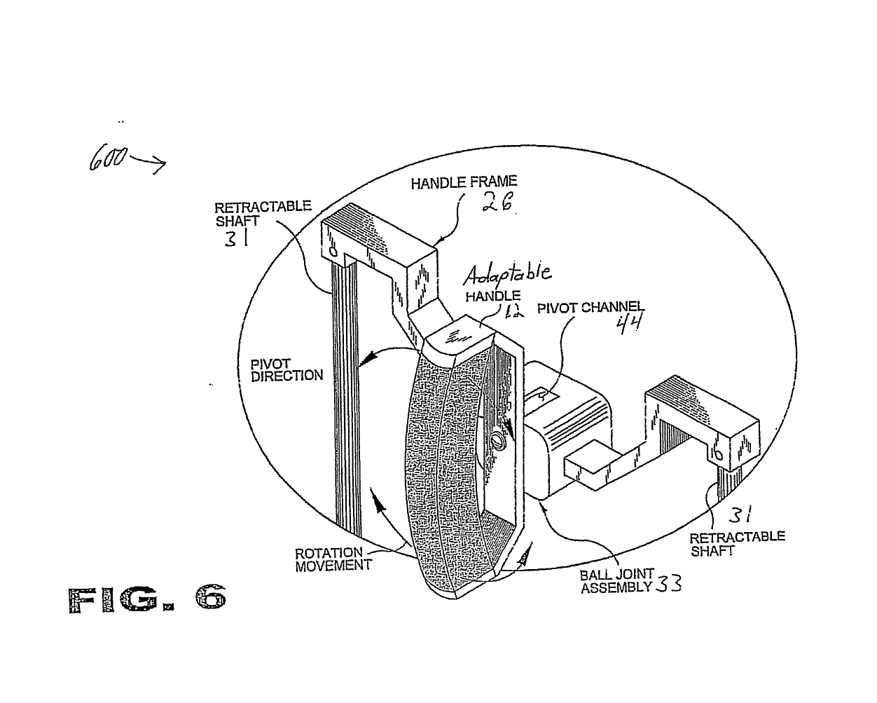

Similarly, FIG. 6 illustrates a system 600, which shows the detailed perspective 400 with the adaptable handle 12 rotated and pivoted. As in system 500, the adaptable handle 12 may rotate to accommodate the user's hand, arm, wrist, or elbow position. Likewise, as shown in the system 600, the adaptable handle 12 may pivot to similarly accommodate the user 14. In the preferred embodiment, the pivot movement may allow the adaptable handle 12 to pivot 90 degrees. The pivot channel 44 of the preferred embodiment allows the adaptable handle 12 to pivot so the handle shaft 42 moves away from a user 14 pulling the wheeled luggage 10. The limited range of pivot movement is preferred as a balance of flexibility and strength to provide for optimal comfort and control. However, the benefits of the adaptable handle 12 pivot movement for a user 14 may be achieved by an adaptable handle 12 which pivots more, or less, than 90 degrees. Alternatively, the pivot channel 44 may allow the adaptable handle 12 to pivot toward a user 14 pulling the wheeled luggage 10. In another alternative embodiment, the pivot channel may allow the adaptable handle 12 to pivot both toward and away from a user 14 pulling the luggage. Accordingly, any degree of pivot movement may be used.

The rotation and pivot movement of the adaptable handle 12 as shown in systems 500 and 600 preferably combine during transportation of the wheeled luggage 12 to provide a natural and comfortable experience for a user 14. The adaptable handle 12 may rotate or pivot to accommodate the arm, hand, wrist, or elbow position of a user. Accordingly, any degree of rotation or pivot movement may be used with the ball joint mechanism 350.

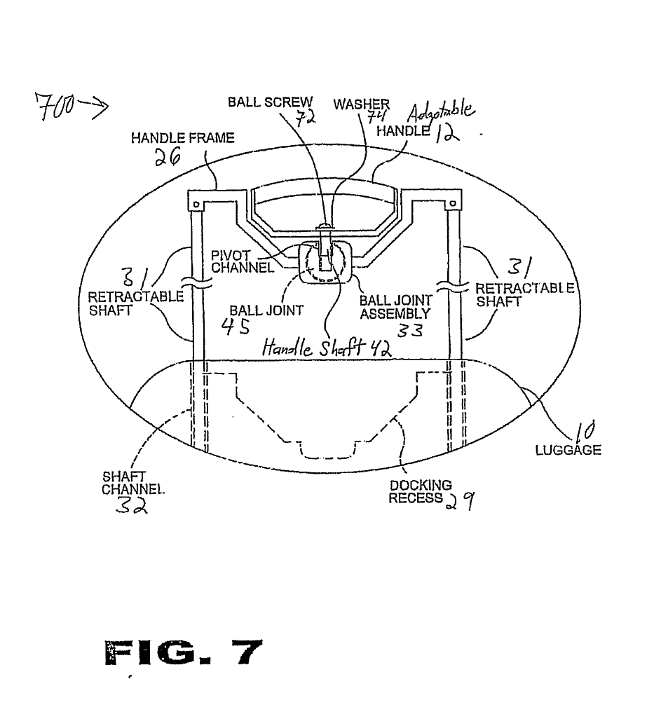

FIG. 7 illustrates a system 700, which shows a front view of an embodiment of the present invention. The wheeled luggage 10 is shown with the retractable shafts 31 in the extended position. The docking recess 29 and shaft channels 32 are depicted in hidden line. The retractable shafts 31 are attached to the handle frame 26. The handle frame 26 is connected to the ball joint assembly 33. The ball joint assembly 33 and ball joint 45 are connected to the adaptable handle 12 by a ball screw 72, a washer 74, and the handle shaft 42, for example. However, any technique or device may be used to connect the ball joint 45 to the adaptable handle 12. A docking recess 29 is also shown as part of the wheeled luggage 10. The docking recess 29 may allow the handle frame 26 to retract into the wheeled luggage 10, similar to the retractable shafts 31 retracting into the wheeled luggage 10.

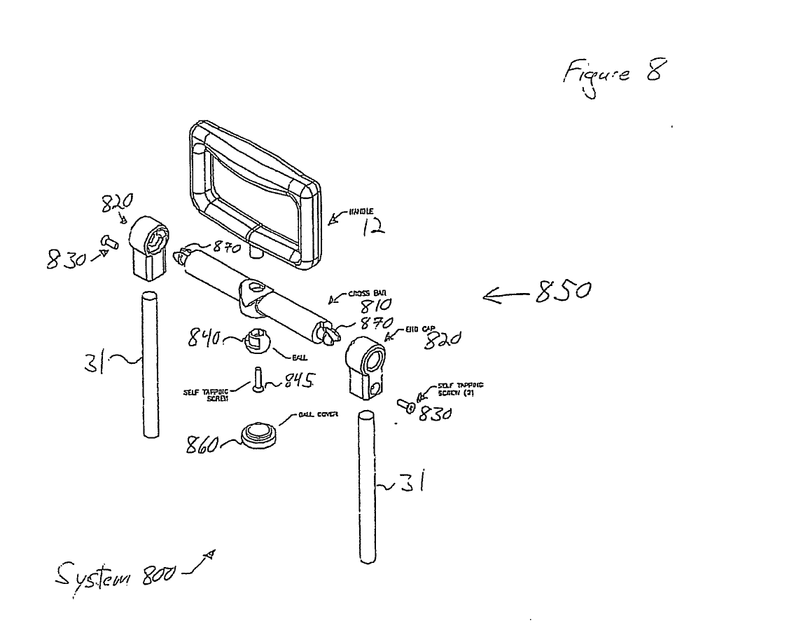

In an alternative embodiment, the ball joint mechanism 350 may be replaced by a cross bar mechanism 850. FIG. 8 illustrates a system 800, which shows an extended, perspective view of an embodiment of the present invention. The embodiment as shown in FIG. 8 is a cross bar mechanism 850. The cross bar mechanism allows the adaptable handle 12 to rotate or pivot according to the position of a user's hand, wrist, arm, or elbow, for example. The cross bar mechanism 850 utilizes a ball 840 to allow the adaptable handle 12 to rotate on an axis substantially parallel to the retractable shafts 31 and a plurality of end caps 820 to allow the adaptable handle 12 to pivot on an axis substantially perpendicular to the retractable shafts 31.

The system 800 illustrates the adaptable handle 12 connected to a cross bar 810 by a ball 840, and a self tapping ball screw 845. The ball 840 is encased in the cross bar 810, for example, and allows the adaptable handle 12 to rotate freely. In the preferred embodiment, the ball 840 is notched to permit the adaptable handle 12 to freely rotate on an axis substantially parallel to the retractable shafts 31. Preferably, the ball 840 is partially notched, as shown in FIG. 8, to restrict the rotation of the adaptable handle 12. Preferably, the rotation of the adaptable handle 12 is restricted to be substantially perpendicular with the crossbar 810. For example, the adaptable handle 12 may rotate 90 degrees clockwise and 90 degrees counter-clockwise. The limited rotation provides strength and stability to the rotation of the adaptable handle 12. Alternatively, the ball 840 may be notched to allow other angles of rotation of the adaptable handle 12, including full 360 degree rotation. Alternatively, the ball 840 does not have a notch and permits the adaptable handle 12 to freely rotate, up to 360 degrees. Accordingly, any degree of rotation may be used.

The ball cover 860 covers the opening in the cross bar 810 which contains the ball 840 and the self tapping ball screw 845. In the preferred embodiment, the cross bar 810 is connected to two end caps 820 by plugs 870 at the ends of the cross bar 810. The end caps 820 allow plugs 870 on the cross bar 810 to be inserted into the end caps 820. The plugs 870 are preferably tapered to allow the plugs 870 to be inserted into the end caps 820. The plugs 870 also preferably have a ridge allowing the plugs 870 to lock into the end caps 820.

The end caps 820 secure the cross bar 810 to the retractable shafts 31 while allowing the cross bar 810 free pivot movement along an axis substantially perpendicular to the retractable shafts 31. In the preferred embodiment, the pivot movement may allow the adaptable handle 12 to pivot 180 degrees. The cross bar 810 of the preferred embodiment may allow the adaptable handle 12 to pivot so the adaptable handle 12 moves away from a user 14 pulling the wheeled luggage 10. The limited range of pivot movement is preferred as a balance of flexibility and strength to provide for optimal comfort and control. However, the benefits of the adaptable handle 12 pivot movement for a user 14 may be achieved by an adaptable handle 12 which pivots more, or less, than 180 degrees. Alternatively, the cross bar 810 may allow the adaptable handle 12 to pivot toward a user 14 pulling the wheeled luggage 10. In another alternative embodiment, the cross bar 810 may allow the adaptable handle 12 to pivot both toward and away from a user 14 pulling the luggage. Accordingly, any degree of pivot movement may be used.

In an embodiment, the end caps 820 are secured to the retractable shafts 31 by two self tapping end cap screws 830, for example. Alternatively, the end caps 820 may be part of the retractable shafts 31. Similar to the ball joint mechanism 350, the crossbar mechanism 850 and the retractable shafts 31 may retreat into shaft channels 32 (not shown). Alternatively, both the retractable shafts 31 as well as the end caps 830 may retreat into shaft channels 32. Moreover, the adaptable handle 12 may pivot to fit between the two retractable shafts 31 and retreat into the docking recess 29. Alternatively, the adaptable handle 12 may lay substantially flush with the exterior of the upper end 24 of the wheeled luggage 10. The adaptable handle 12 may pivot, for example, to lay substantially flush with the exterior of the upper end 24 of the wheeled luggage 10.

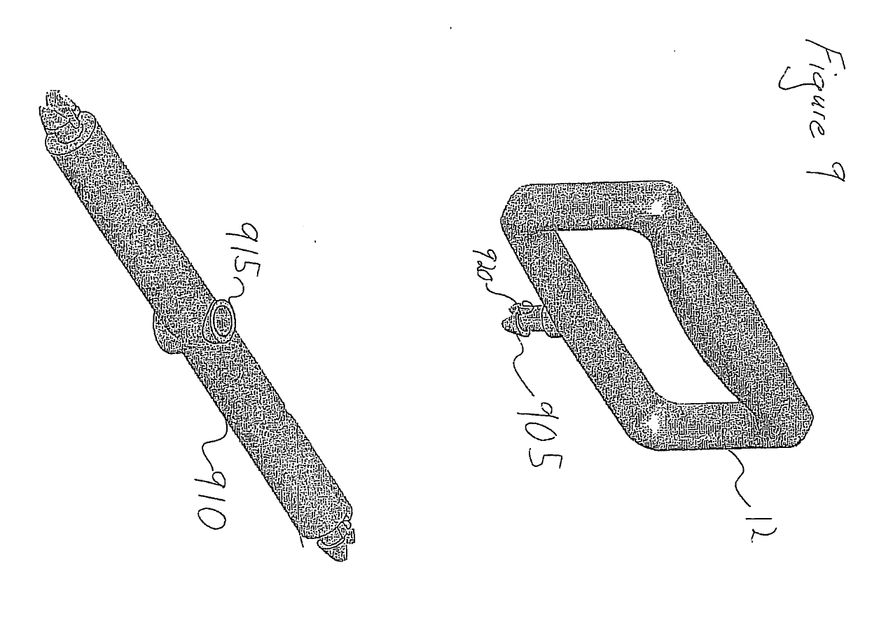

In an alternative embodiment, rotational movement of the adaptable handle 12 may be facilitated by a fitted plug 905 instead of the ball 840, and other associated elements. FIG. 9 shows the adaptable handle 12, the fitted plug 905, and a modified crossbar 910. The fitted plug 905 may be part of the adaptable handle 12, as shown in FIG. 9. Alternatively, the fitted plug 905 may be a separate piece from the adaptable handle 12 and may be attached to the adaptable handle 12 via a screw mechanism, for example. The fitted plug 905 is preferably tapered to allow the fitted plug 905 to be inserted into a hole 915 in the modified crossbar 910. The fitted plug 905 also preferably has a ridge 920 allowing the fitted plug 905 to lock into the modified crossbar 910 upon inserting the fitted plug 905 into the hole 915. The modified crossbar 910 may have similar features as crossbar 810. However, the hole 915 of the modified crossbar 910 may have appropriate dimensions to receive the fitted plug 905. The hole 915 of the modified crossbar 910 also may have appropriate dimensions to lock the fitted plug 905 and the adaptable handle 12 to the modified crossbar 910. When the fitted plug 905 is locked in the modified crossbar 910, the mechanism permits full 360 degree rotation of the adaptable handle 12.

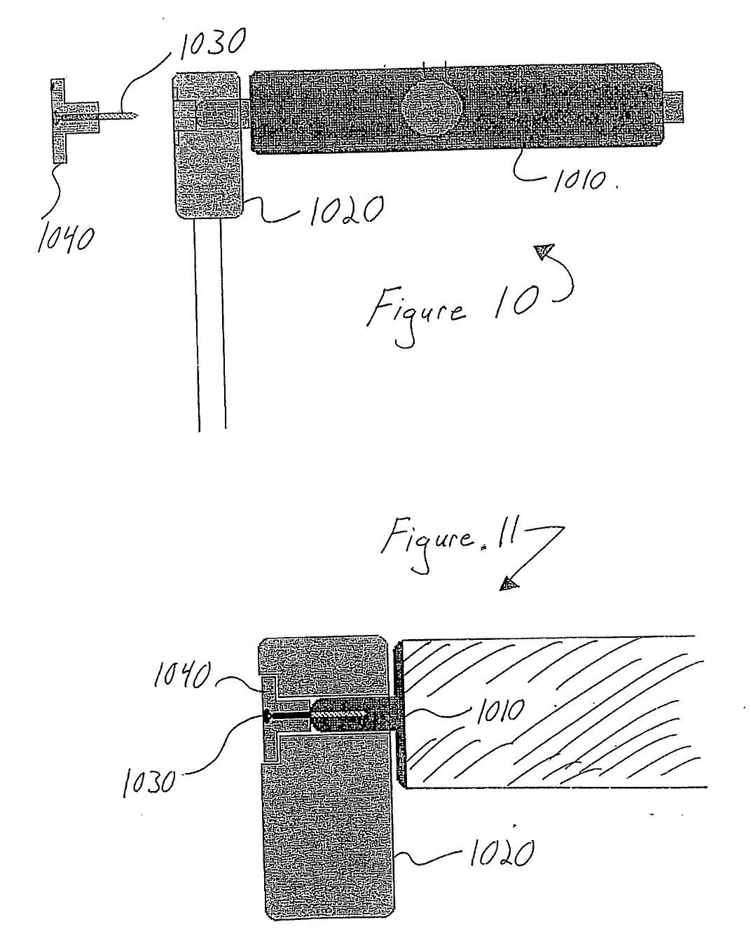

In an alternative embodiment, a modified crossbar 1010 may be connected to modified end caps 1020 by a circular plug attachment 1040 and a self tapping screw 1030. FIG. 10 shows the modified crossbar 1010, the modified end caps 1020, and the self tapping screw 1030, and circular plug attachment 1040. The modified cross bar 1010 is similar to the cross bar 810 and modified cross bar 910 except that the ends of modified crossbar 1010, which may be inserted into the modified end caps 1020, have fittings capable of receiving the self tapping screw 1030 and the modified end caps 1020 are capable of receiving the circular plug attachments 1040. The self tapping screw 1030 may have a circular plug attachment 1040 which houses a portion of the self tapping screw 1030. The modified end caps 1020 have a first side capable of receiving the self tapping screw 1030 as well as the circular plug attachment 1040. The modified end caps 1020 have a second side capable of receiving the end of the modified crossbar 1010.

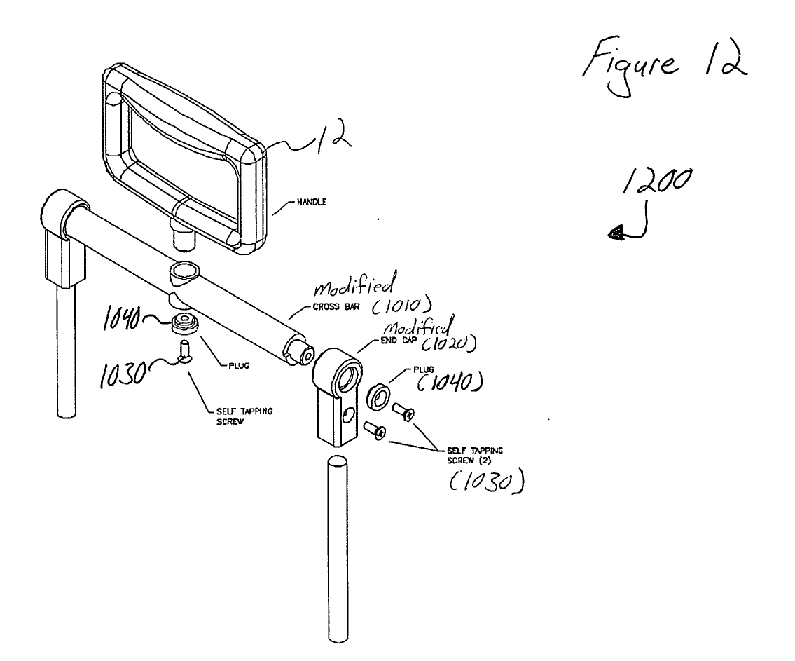

Together, the circular plug attachment 1040 and the self tapping screw 1030 may be inserted into the first side of the modified end cap 1030 and the end of the modified crossbar 1010 may be inserted into the second side of the modified end cap 1020. The self tapping screw 1030 may be screwed into said modified cross bar 1010, fastening the circular plug attachment 1040 and the modified crossbar 1010 within the modified end caps 1020. FIG. 11 illustrates the circular plug attachment 1040 and the self tapping screw 1030 connected to the modified crossbar 1010 through the modified end cap 1020.

FIG. 12 illustrates a system 1200 as an embodiment of the present invention. FIG. 12 illustrates similar features as previous embodiments, except the modified cross bar 1010 is shown connected to the modified end caps 1020 by the circular plug attachment 1040 and self tapping screw 1030. The handle 12 is also shown connected to the modified cross bar 1010 by a circular plug attachment 1040 and self tapping screw 1030.

Multiple techniques in connecting the cross bar to the end caps, and the cross bar to the adaptable handle have been described above. It should be noted that any combination of these techniques may be combined to utilize various embodiments of the invention. For example, the handle may be connected to the crossbar by a plug, and the crossbar connected to the end caps by a circular plug assembly, or vice versa. As another example, the handle may be connected to the crossbar by a ball assembly, whereas the crossbar may be fastened to the end caps by a circular plug attachment. Accordingly, any technique for fastening the various components of an embodiment together may be used. Moreover, any technique which allows a luggage handle to rotate or pivot may be used.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1) A wheeled luggage assembly for use with the type of wheeled luggage which has a retractable device, the retractable device connected to a docking recess which is connected to the wheeled luggage, said wheeled luggage assembly comprising:
a handle which rotates or pivots.

2) A wheeled luggage assembly as set forth in claim 1, wherein the handle is attached to the retractable device.

3) A wheeled luggage assembly as set forth in claim 1, wherein the handle retracts into the docking recess.

4) A system for transporting wheeled luggage using an adaptable handle, said system comprising:
a ball joint mechanism for allowing rotation or pivot movement of the adaptable handle, said ball joint mechanism comprising a ball joint connected to said adaptable handle by a handle shaft, the ball joint within a ball joint assembly, said ball joint assembly being connected to a handle frame, said handle frame being connected to at least one retractable shaft.

5) The system of claim 4, wherein said ball joint assembly contains a pivot channel for allowing pivot movement of said adaptable handle.

6) The system of claim 4, wherein said ball joint is connected to said adaptable handle by a screw and washer assembly.

7) A system for transporting wheeled luggage using an adaptable handle, said system comprising:
a cross bar mechanism for allowing rotation or pivot movement of the adaptable handle, said cross bar mechanism comprising said adaptable handle connected to a ball encased in a cross bar, said ball allowing rotation of said adaptable handle, said cross bar connected to a plurality of end caps, said end caps allowing pivot movement of said adaptable handle.

8) The system of claim 7, wherein said adaptable handle is connected to said ball by a self tapping ball screw.

9) The system of claim 7, wherein said ball is notched to allow less than 360 degree rotation of said adaptable handle.

10) The system of claim 7, said cross bar connected to said plurality of end caps by plugs on said cross bar.

11) The system of claim 10, wherein said plugs are tapered to allow the plugs to be inserted into the end caps.

12) The system of claim 10, wherein said plugs have a ridge allowing the plugs to lock into said end caps.

13) The system of claim 7, wherein said cross bar is secured within said plurality of end caps by screwing a circular plug attachment into said cross bar.

14) The system of claim 7, wherein said plurality of end caps are connected to a plurality of retractable shafts, each retractable shaft being connected to a single end cap.

15) The system of claim 7, wherein said end caps are connected to said plurality of retractable shafts by a self tapping end cap screw.

16) The system of claim 7, wherein said end caps are part of said retractable shafts.

17) The system of claim 7, wherein said wheeled luggage contains a docking recess to allow said adaptable handle to pivot between said retractable shafts and retreat into said docking recess.

18) A system for transporting wheeled luggage using an adaptable handle, said system comprising:
a cross bar mechanism for allowing rotation or pivot movement of the adaptable handle, said cross bar mechanism comprising said adaptable handle connected to a cross bar by a fitted plug, said fitted plug allowing rotation of said adaptable handle, said cross bar connected to a plurality of end caps, said end caps allowing pivot movement of said adaptable handle.

19) The system of claim 18, wherein said fitted plug is tapered to allow the fitted plug to be inserted into a hole in the crossbar.

20) The system of claim 18, wherein said fitted plug has a ridge allowing the fitted plug to lock into said crossbar upon inserting the fitted plug into a hole.

21) The system of claim 18, said cross bar connected to said plurality of end caps by plugs on said cross bar.

22) The system of claim 18, wherein said cross bar is secured within said plurality of end caps by screwing a circular plug attachment into said cross bar.

23) The system of claim 18, wherein said plurality of end caps are connected to a plurality of retractable shafts, each retractable shaft being connected to a single end cap.

24) The system of claim 18, wherein said end caps are connected to said retractable shafts by a self tapping end cap screw.

25) The system of claim 18, wherein said end caps are part of said retractable shafts.

26) The system of claim 18, wherein said wheeled luggage contains a docking recess to allow said adaptable handle to pivot between said retractable shafts and retreat into said docking recess.
